(19) United States
(12) Patent Application Publication
(10) Pub. No.: US 2010/0196755 A1
(43) Pub. Date: Aug. 5, 2010

(54) ELECTRODE ASSEMBLY AND SECONDARY BATTERY HAVING THE SAME

(75) Inventors: Se-Ho Park, Suwon-si (KR); Bong-Chull Kim, Suwon-si (KR); Cheol-Hee Hwang, Suwon-si (KR); Dong-Yung Kim, Suwon-si (KR)

Correspondence Address: STEIN MCEWEN, LLP, 1400 EYE STREET, NW, SUITE 300, WASHINGTON, DC, 20005, US

(73) Assignee: Samsung SDI Co., Ltd., Suwon-si (KR)

(21) Appl. No.: 12/700,187

(22) Filed: Feb. 4, 2010

(30) Foreign Application Priority Data
Feb. 5, 2009 (KR) 10-2009-0009342

(51) Int. Cl. H01M 2/00; H01M 4/58

(52) U.S. Cl. 429/163; 429/231.8; 429/223

(57) ABSTRACT

An electrode assembly and a secondary battery having the same, which include a positive electrode having a positive electrode active material layer deposited on a positive electrode collector, a negative electrode having a negative electrode active material layer deposited on a negative electrode collector, and a separator separating the positive electrode from the negative electrode. The negative electrode active material layer includes a negative electrode active material of a metal-graphite complex, and the thickness of the negative electrode collector is in the range from 16.3 to 24.2% of that of the negative electrode active material layer. The thickness of the secondary battery can be reduced while maintaining battery capacity by controlling the ratio of the thickness of the negative active material layer to the negative electrode collector and controlling the tensile stress of the negative electrode collector.

### CROSS-REFERENCE TO RELATED APPLICATION

This application claims the benefit of Korean Patent Application No. 10-2009-0009342, filed Feb. 5, 2009 in the Korean Intellectual Property Office, the disclosure of which is incorporated herein by reference.

### BACKGROUND OF THE INVENTION

1. Field of the Invention

Aspects of the present invention relate to an electrode assembly and a secondary battery having the same, and more particularly, to a secondary battery where the thickness of the battery can be reduced without degrading battery performance.

2. Description of the Related Art

Lithium metals have been conventionally used as negative electrode active materials. However, lithium metals form dendrites, which can cause short circuits in a battery and thus explosion of the battery. As a result, lithium metals are being widely replaced by carbonaceous materials.

The carbonaceous active materials used as negative electrode active materials for lithium batteries include crystalline carbon such as graphite and artificial graphite, and amorphous carbon, such as soft and hard carbon. However, neither form of carbon is ideal. Amorphous carbon has high capacity, but significant irreversibility during charging or discharging of the battery. Crystalline carbon, e.g., graphite, which is also used as a negative electrode active material, has a high theoretical limit capacity of 372 mAh/g, but it is highly susceptible to degradation of life span. Moreover, since the theoretical capacity of the graphite or other carbonaceous active material is only slightly higher, at about 380 mAh/g, they cannot be used as negative electrode active materials for high-capacity lithium batteries.

In order to solve these problems, research on developing lithium batteries using a metal-graphite complex as a negative electrode active material, is being conducted. The metals that have been used in such complexes include aluminum, germanium, silicon, tin, zinc and lead.

However, these metallic negative electrode active materials having high capacity expand to about 300 to 400% of their original volume since inorganic particles such as silicon or tin included in the negative electrode active material are intercalated with lithium during charging of the battery. Because of this volume expansion, the thickness of a battery's negative electrode plate increases greatly compared to conventional graphite or carbonaceous materials. When the volume increase reaches or exceeds a predetermined level, the electrode jelly roll is under increasing stress and therefore twists, resulting in deformation of the jelly roll.

Meanwhile, batteries using a metal-graphite complex as a negative electrode active material use an 8 μm-thick negative electrode base material. Here, as the thickness of the negative electrode base material is increased by design, the stress limit of the base material increases to prevent the deformation of the jelly roll. To manufacture a high capacity lithium battery, it is desirable that more active materials should be included in the available volume. However, an increase in thickness of the base material leads to reduction in the available space for the active material, resulting in a decrease in capacity.

### SUMMARY OF THE INVENTION

Aspects of the present invention provide a secondary battery in which the thickness of the battery can be reduced without degrading battery performance. Aspects of the present invention also provide a secondary battery in which the thickness of the battery can be reduced without a decrease in capacity by controlling the thickness of the negative electrode active material layer with respect to the thickness and tensile strength of the negative electrode collector.

According to an exemplary embodiment of the present invention, a negative electrode includes a negative electrode collector and a negative electrode active material layer deposited on the negative electrode collector. Here, the thickness of the negative electrode collector is in the range from 16.3 through 24.2% of that of the negative electrode active material layer.

According to another exemplary embodiment of the present invention, an electrode assembly includes a positive electrode having a positive electrode active material layer deposited on a positive electrode collector, a negative electrode having a negative electrode active material layer deposited on a negative electrode collector, and a separator separating the positive electrode from the negative electrode. Here, the negative electrode active material layer includes a negative electrode active material of a metal-graphite complex, and the thickness of the negative electrode collector is in the range from 16.3 through 24.2% of that of the negative electrode active material layer.

According to still another exemplary embodiment of the present invention, a lithium battery includes: an electrode assembly; a can housing the electrode assembly; a cap on top of the can; and an electrolyte injected into the can. Here, the electrode assembly includes a positive electrode having a positive electrode active material layer deposited on a positive electrode collector, a negative electrode having a negative electrode active material layer deposited on a negative electrode collector, and a separator separating the positive electrode from the negative electrode. The negative electrode active material layer includes a negative electrode active material of a metal-graphite complex, and the thickness of the negative electrode collector is in the range from 16.3 to 24.2% of that of the negative electrode active material layer.

In these exemplary embodiments, the negative electrode collector may have a tensile stress of 294.0 through 970.0 MPa. The negative electrode collector may have a thickness of 9 through 15 μm.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is an exploded perspective view of a secondary battery according to an exemplary embodiment of the present invention;

FIG. 2 is a cross-sectional view of an electrode assembly according to another exemplary embodiment of the present invention;

FIG. 3 is a graph showing the increase in thickness versus tensile stress of a negative electrode collector according to another exemplary embodiment of the present invention;

FIG. 4 is a graph showing the increase in thickness versus thickness of the negative electrode collector of FIG. 3; and

FIG. 5 is a graph showing capacity per volume versus thickness of the negative electrode collector of FIG. 3.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures. Further, in the drawings, the length and thickness of a layer and a region may be exaggerated for convenience.

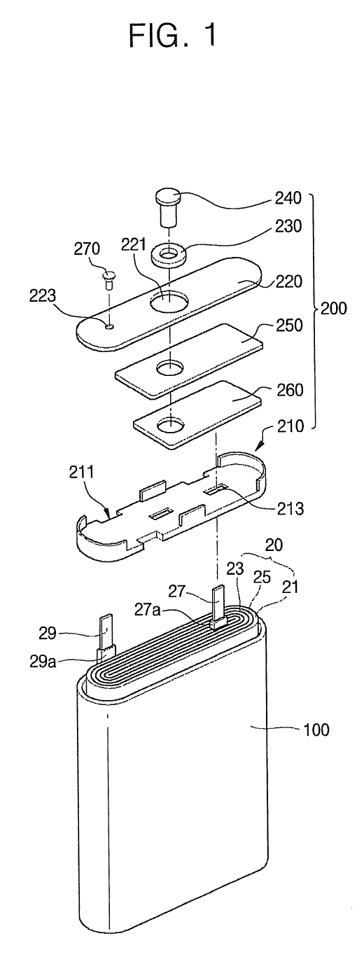

FIG. 1 is an exploded perspective view of a secondary battery according to an exemplary embodiment of the present invention. Referring to FIG. 1, the secondary battery includes a can 100, an electrode assembly 20 housed in the can 100, and a cap assembly 200 disposed on an opening of the can 100.

The can 100 may be formed of a metallic material to have an open top. The can 100 may house the electrode assembly 20 and an electrolyte, and also house an insulating case 210 over the electrode assembly. The metallic material may be aluminum, an aluminum alloy or stainless steel, which are light and flexible. When the can 100 is formed of a metallic material, the can 100 can conduct electricity, can be designed to have polarity, and thus can be used as an electrode terminal. The can 100 may have a rectangular shape or an oval shape having rounded corners, and the open top of the can 100 is sealed with the cap assembly 200 by welding or thermal bonding.

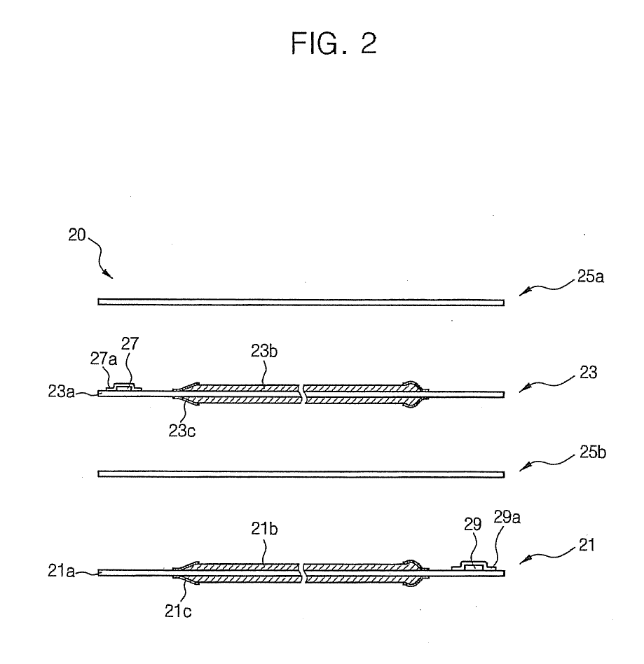

The electrode assembly 20 includes a positive electrode 21 formed by applying a positive electrode active material to a positive electrode collector 21a (see FIG. 2), a negative electrode 23 formed by applying a negative electrode material to a negative electrode collector 23a (see FIG. 2), and a separator 25 interposed between the positive electrode 21 and the negative electrode 23 to prevent a short circuit between the two electrodes 21 and 23 and to allow migration of lithium ions. A positive electrode non-coating portion (not shown) to which the positive electrode active material is not applied is formed on the positive electrode 21, and a negative electrode non-coating portion (not shown) to which the negative electrode active material is not applied is formed on the negative electrode 23.

A first electrode tab 29 electrically connected to the cap plate is joined to the positive electrode non-coating portion, and a second electrode tab 27 electrically connected to an electrode terminal is joined to the negative electrode non-coating portion. Hereinafter, the first electrode tab 29 is referred to as positive electrode tab 29, and the second electrode tab 27 is referred to as negative electrode tab 27.

Protection members 27a and 27b may be respectively disposed at portions of the positive electrode 21 and the negative electrode 23 from which the positive electrode tab 29 and the negative electrode tab 27 extend. Protection members 27a and 27b are used in order to prevent a short circuit between the electrodes 21 and 23. Here, the positive electrode tab 29 and the negative electrode tab 27 may be joined to the positive electrode non-coating portion and the negative electrode non-coating portion by ultrasonic welding, but these aspects of the present invention are not limited thereto.

The separator 25 is generally formed of a thermoplastic resin such as polyethylene (PE) or polypropylene (PP), and the surface of separator 25 has a porous structure. When an increase in temperature inside the battery reaches the melting point of the thermoplastic resin, the separator 25 melts and blocks a through-hole so that the porous structure becomes an insulating film. Therefore, the migration of lithium ions between the positive electrode 21 and the negative electrode 23 is interrupted, and thus no more current flows, resulting in interruption of the increase in temperature inside the battery.

The cap assembly 200 bonded to the open top of the can 100 includes an insulating case 210, a cap plate 220, an insulating gasket 230, an electrode terminal 240, an insulating plate 250, a terminal plate 260 and an electrolyte inlet plug 270. First, the insulating case 210 is disposed over the electrode assembly 20 inserted into the can 100 to prevent movement of the electrode assembly 20. The insulating case 210 has supporting parts 214 functioning as walls to properly place the terminal plate 260 and the insulating plate 250 covering the terminal plate 260.

Further, the insulating case 210 separates the positive electrode tab 29 a predetermined distance apart from the negative electrode tab 27 to prevent a short circuit therebetween, and has an electrode tab leading groove 211 and an electrode tab outlet 213, which function as guides leading the electrode tabs 27 and 29 out of the can 100. Generally, the positive electrode tab 29 may be disposed outside the electrode assembly and projects through the electrode tab leading groove 211, and the negative electrode tab 27 may be disposed in the middle of the electrode assembly and project through the electrode tab outlet 213. Alternatively, the negative electrode tab 27 may be disposed outside the electrode assembly and project through the electrode tab leading groove 211, and the positive electrode tab 29 may be disposed in the middle of the electrode assembly and project through the electrode tab outlet 213. That is, the positions of the positive electrode tab 29 and the negative electrode tab 27 are not limited to these aspects of the present invention.

While the above-described secondary battery was formed in a prismatic shape, the secondary battery can also be formed in a cylindrical or pouch shape. That is, the shape of the secondary battery is not limited to these aspects of the present invention.

FIG. 2 is a cross-sectional view of the electrode assembly according to an exemplary embodiment of the present invention. Referring to FIG. 2, the electrode assembly 20 includes a first electrode 21 (hereinafter, a positive electrode), a second electrode 23 (hereinafter, a negative electrode) and separators 25a and 25b.

The electrode assembly 20 is formed in a jelly roll shape by stacking and winding the positive electrode 21, the negative electrode 23 and the separators 25a and 25b. The separators include a first separator 25b disposed between the positive electrode 21 and the negative electrode 23, and a second separator 25a disposed under or over the both electrodes 21 and 23. The separators 25a and 25b are interposed between contacting portions of the electrodes, and stacked and wound to prevent a short circuit between the electrodes.

First, the positive electrode 21 is composed of a positive electrode collector 21a collecting electrons generated by a chemical reaction and then delivering the electrons to an external circuit, and a positive active material layer 21b to which a positive electrode slurry including the positive electrode active material is applied to one or both surfaces of the positive electrode collector 21a. The positive electrode 21 may include an insulating member 21c formed to cover one or both ends of the positive electrode active material layer 21b.

The insulating member 21c may be an insulating tape which is composed of an adhesive layer and an insulating film attached to one side of the adhesive layer. The shape and material of the insulating member 21c are not limited in these aspects of the present invention. For example, the adhesive layer may be formed of an ethylene-acrylic ester copolymer, a rubber-based adhesive or an ethylene acetic acid vinyl copolymer, and the insulating film may be formed of polypropylene, polyethylene terephthalate or polyethylene naphthalate.

The positive electrode slurry including the positive electrode active material is not applied to one or both ends of the positive electrode collector 21a, thereby forming the positive electrode non-coating portion exposing the positive electrode collector 21a, and the positive electrode tab 29 delivering electrons collected in the positive electrode collector 21a to an external circuit and formed in a thin film type of nickel or aluminum is joined to the positive electrode non-coating portion.

The protection member 29a may be formed over a portion to which the positive electrode tab 29 is joined. The protection member 29a protects the joined portion and thus prevents a short circuit, and is preferably formed of a heat-resistant material such as a polymer resin, e.g., polyester. However, the shape and material of the protection member 29a are not limited in these aspects of the present invention.

The positive electrode collector 21a may be formed of stainless steel, nickel, aluminum, titanium, an alloy thereof, or stainless steel surface-treated with carbon, nickel, titanium or silver, and preferably aluminum or an aluminum alloy. However, the shape and thickness of the positive electrode collector 21a are not limited in these aspects of the present invention.

The positive electrode collector 21a may be formed in a foil, film, sheet, punched, porous or foamy shape, and generally have a thickness of 1 to 50 μm and preferably 1 to 30 μm. However, the shape and thickness thereof are not limited in these aspects of the present invention.

Examples of the positive electrode active material may include any lithium-containing transition metal oxides including LiCoO₂, LiNiO₂, LiMnO₂, LiMn₂O₄ and LiNi_{1-x-y}COₓM_{y}O₂ (wherein, 0≦x≦1, 0≦y≦1, 0≦x+y≦1, and M is a metal, e.g., Al, Sr, Mg or La). However, the kind of the positive electrode active material is not limited in these aspects of the present invention.

The positive electrode active material layer may further include a binder functioning as a buffer for pasting the active material, self-attachment of the active material, attachment to the collector, and expansion and contraction of the active material. The binder may include polyvinylidene fluoride, a polyhexafluoropropylene-polyvinylidene fluoride copolymer, poly(vinylacetate), polyvinyl alcohol, polyethylene oxide, polyvinylpyrrolidone, alkylated polyethylene oxide, polyvinylether, poly(methyl methacrylate), poly(ethyl acrylate), polytetrafluoroethylene, polyvinyl chloride, polyacrylonitrile, polyvinylpyridine, styrene-butadiene rubber or acrylonitrile-butadiene rubber.

The positive electrode active material layer may further include a conductive material improving electron conductivity, which may be at least one material selected from the group consisting of graphite-, carbon black-, metal- and metal compound-based conductive materials. Examples of the graphite-based conductive material may include artificial graphite and natural graphite; examples of the carbon black-based conductive material may include acetylene black, ketjen black, denka black, thermal black and channel black; and examples of the metal or metal compound-based conductive material may include tin, tin oxide, tin phosphate (SnPO₄), titanium oxide, potassium titanate, and perovskites such as LaSrCoO₃ and LaSrMnO₃.

The negative electrode 23 is composed of the negative electrode collector 23a collecting electrons generated by a chemical reaction and delivering the electrons to an external circuit, and the negative electrode active material layer 23b to which the negative electrode slurry including the negative electrode active material is applied to one or both surfaces of the negative electrode collector 23a. The negative electrode 23 may also include an insulating member 23c formed to cover at one or both ends of the negative electrode active material 23b.

The insulating member 23c may be an insulating tape composed of an adhesive layer and an insulating film attached to the one side of the adhesive layer. However, the shape and material of the insulating member 23c are not limited in these aspects of the present invention. For example, the insulating layer may be formed of an ethylene-acrylic ester copolymer, a rubber-based adhesive or an ethylene acetic acid vinyl copolymer. The insulating film may be formed of polypropylene, polyethylene terephthalate or polyethylene naphthalate.

In addition, the negative electrode slurry including the negative electrode active material is not applied to one or both ends of the negative electrode collector 23a, thereby forming the negative electrode non-coating portion exposing the negative electrode collector 23a, and the negative electrode tab 27 which delivers the electrons collected in the negative electrode collector 23a to an external circuit and is formed of a nickel thin film joined to the negative electrode non-coating portion.

A protection member 27a may cover the negative electrode tab 27 to be joined. The protection member 27a protects the joined portions to prevent a short circuit, and is preferably formed of a heat-resistant material such as a polymer resin, e.g., polyester. However, the shape and material of the protection member 27a are not limited in these aspects of the present invention.

The negative electrode collector 23a may be formed of stainless steel, nickel, copper, titanium, an alloy thereof, or stainless steel surface-treated with carbon, nickel, titanium or silver, and preferably copper or a copper alloy. However, the material of the negative electrode collector 23a is not limited according to these aspects of the present invention.

The negative electrode collector 23a may be formed in a foil, film, sheet, punched, or porous or foamy shape, and have a thickness of 9 through 15 μm, and preferably, 15 μm. The negative electrode collector 23a preferably has a tensile stress of 294.0 through 970.0 MPa. When the tensile stress of the negative electrode collector 23a is less than 294.0 MPa, reduction of the thickness of the battery is insignificant, and when the tensile stress of the negative electrode collector 23a is more than 970.0 MPa, the capacity per volume of the negative electrode 23 is low, and thus there is no advantage in using a metal-graphite complex as the negative electrode active material.

The negative electrode active material layer may be formed of a negative electrode active material of a metal-graphite complex. For example, the negative electrode active material used herein is composed of a graphite core particle, a metal particle disposed on a surface of the graphite core particle and a carbon film coating the graphite core particle and the metal particle.

The graphite core particle is a material capable of reversibly intercalating or deintercalating lithium, and may be at least one material selected from the group consisting of artificial graphite, natural graphite, graphitized carbon fiber, a graphitized mesocarbon microbead and amorphous carbon. Here, the graphite core particle may have an average diameter size of 1 through 20 μm. When the average diameter size of the graphite core particle is less than 1 μm, it is difficult for the metal particle disposed in the carbon film to be disposed on the surface of the graphite core particle, and when the average diameter size of the graphite core particle is more than 20 μm, it is difficult to coat the carbon film uniformly.

The carbon film is formed by annealing a polymer such as a vinyl-based resin, a cellulose-based resin, a phenol-based resin, a pitch-based resin or a tar-based resin, which are preferably relatively less graphitized and amorphous. Since the material is relatively less graphitized, there is no risk of electrolyte decomposition while electrolyte is in contact with the carbon film, and thus charge/discharge efficiency of the negative electrode active material may increase. Specifically, the carbon film has a low reactivity to the electrolyte, and also coats a metal nanoparticle having a relatively high reactivity to the electrolyte, so that the carbon film functions as a reaction stop layer preventing decomposition of the electrolyte. Here, the carbon film preferably has a thickness of 1 through 4 μm. When the thickness of the carbon film is less than 1 μm, it is difficult to dispose the metal particle on the surface of the graphite core particle, resulting in degradation of cycle characteristics, and when the thickness of the carbon film is more than 4 μm, it is not preferable because an increase of an irreversible capacity can be caused by the amorphous carbon.

The metal particle is a metallic material capable of forming an alloy with lithium and reversibly intercalating or deintercalating lithium ions. Since the metal particle has a higher intercalating capability with respect to lithium ions than the graphite core particle, the charge/discharge capacity of the total negative electrode active material can be increased.

The metal particle includes at least one of the metals or metal compounds forming an alloy with lithium, which may be at least one metal selected from the group consisting of Cr, Sn, Si, Al, Mn, Ni, Zn, Co, In, Cd, Bi, Pb and V. The most preferable example of the metal particle is Si, which has a very high theoretical capacity of 4017 mAh/g.

The metal particle is formed to have an average particle size of 0.01 through 1.0 μm, and preferably 0.05 to 0.5 μm. When the particle size of the metal particle is less than 0.01 μm, dispersion in the carbon particles is non-uniform because of increased agglomeration between the particles. At that particle size, it is physically difficult to use metal particles in powder form. Also, a side reaction stimulating decomposition of the electrolyte may be caused due to the increased specific surface area of the metal particle. Further, when the particle size of the metal particle is more than 1.0 μm, battery capacity may decrease as the volume expansion of the metal particle during charging or discharging of the battery is higher.

A metal-graphite complex of the negative electrode active material includes a metallic material capable of forming an alloy with lithium and reversibly charging or discharging with respect to lithium as in the carbonaceous material. Therefore, the negative electrode active material can have higher capacity and energy density, and intercalate or deintercalate more lithium ions than a negative electrode active material formed of the carbonaceous material. For these reasons, a battery having high capacity can be manufactured. The negative electrode active material layer 23b may use a mixture of a conductive material such as carbon black, a binder such as polyvinylidene fluoride (PVDF), styrene butadiene rubber (SBR), polytetrafluoroethylene (PTFE) or polyamide-imide (PAI) for fixing the active material and the negative electrode active material.

Here, the thickness of the negative electrode collector 23a may be 16.3 through 24.2% of that of the negative electrode active material layer. When the thickness of the negative electrode collector 23a is less than 16.3% of the thickness of the negative electrode active material layer, reduction of the rate of increase in thickness of the battery is insignificant, and when the thickness of the negative electrode collector 23a is more than 24.2% of the thickness of the negative electrode active material layer, the capacity maintenance rate is decreased.

That is, in order to prevent an increase in thickness of the battery, the thickness of the negative electrode collector 23a is increased, thereby increasing the stress limit applicable to the negative electrode collector 23a in order to prevent the deformation of the jelly-roll. That is, some increased thickness of the base material can reduce overall thickness of the battery. However, since the base material is not the factor affecting the capacity, a base material that is too thick can cause a reduction in capacity.

The separators 25a and 25b are generally formed of a thermoplastic resin such as polyethylene or polypropylene. However, the material and structure of the separator are not limited in these aspects of the present invention.

A secondary battery according to an exemplary embodiment of the present invention will be described. A cylindrical secondary battery includes an electrolyte. The electrolyte according to the aspects of the present invention includes a non-aqueous organic solvent, which may be a carbonate, an ester, an ether or a ketone. The carbonate may be dimethyl carbonate (DMC), diethyl carbonate (DEC), dipropyl carbonate (DPC), methyl propyl carbonate (MPC), ethyl propyl carbonate (EPC), ethyl methyl carbonate (EMC or MEC), ethylene carbonate (EC), propylene carbonate (PC), butylene carbonate (BC) or fluoroethylene carbonate (FEC). The ester may be γ-butyrolactone (BL), 5-decanolide, γ-valerolactone, d,l-mevalonolactone, γ-caprolactone, n-methyl acetate, n-ethyl acetate or n-propyl acetate. The ether may be dibutyl ester and the ketone may be poly(vinyl methyl ketone). However, the kind of the non-aqueous organic solvent is not limited to these aspects of the present invention.

When the non-aqueous organic solvent is a carbonate-based organic solvent, a mixture of cyclic carbonate and chain carbonate is preferably used. In this case, the cyclic carbonate is preferably mixed with the chain carbonate in a volume ratio of 1:1 to 1:9, and more preferably 1:1.5 to 1:4. When the mixture is formed in the above-mentioned ratio ranges, the preferred performance of the electrolyte can be achieved.

The electrolyte according to these aspects of the present invention may also include an aromatic carbonaceous organic solvent as well as the carbonate-based solvent. The aromatic carbonaceous organic solvent may be an aromatic hydrocarbon-based compound. Examples of the aromatic carbonaceous organic solvent include benzene, fluorobenzene, chlorobenzene, nitrobenzene, toluene, fluorotoluene, trifluorotoluene and xylene. In the case of the electrolyte including the aromatic hydrocarbon-based organic solvent, the volume ratio of the carbonate-based solvent to the aromatic hydrocarbon solvent may be 1:1 to 30:1. When the mixture is formed in the above-mentioned volume ratio, the electrolyte can achieve the preferred performance.

The electrolyte according to these aspects of the present invention includes a lithium salt, which functions as a source of lithium ions in the battery that are basic to operation of a lithium battery. The lithium salt may be at least one salt selected from the group consisting of LiPF₆, LiBF₄, LiSbF₆, LiAsF₆, LiClO₄, LiCF₃SO₃, LiN(CF₃SO₂)₂, LiN(C₂F₆SO₂)₂, LiAlO₂, LiAlCl₄, and LiN(CₓF₂ₓ₊₁SO₂)(C_{y}F_{2y+1}SO₂) (wherein, x and y are natural numbers), and a mixture thereof.

The lithium salt is used at concentrations ranging from 0.6 through 2.0 M, and preferably 0.7 to 1.6 M. When the concentration of the lithium salt is less than 0.6 M, conductivity of the electrolyte decreases, thus degrading the electrolyte performance, and when the concentration of the lithium salt is more than 2.0 M, viscosity of the electrolyte increases, thus reducing the mobility of lithium ions.

Hereinafter, preparation of exemplary embodiments and comparative examples will be described. However, the following examples are provided only to explain, not to limit, the present invention.

### Example 1

A positive electrode active material of LiCoO₂, a binder of polyvinylidene fluoride (PVDF) and a conductive material of carbon were mixed in a weight ratio of 96:2:2, and then the mixture was dispersed in N-methyl-2-pyrollidone to form a positive electrode active material slurry. The slurry was coated on a 12 μm-thick aluminum foil, and dried and rolled to form a positive electrode. A complex of silicon and graphite was used as a negative electrode active material. The negative electrode active material, a binder of styrene-butadiene rubber and a thickener of carboxymethyl cellulose were mixed in a weight ratio of 97:2:1 and then the mixture was dispersed in water to form a negative electrode active material slurry. The slurry was coated on a 15 μm-thick copper foil, which is a negative electrode collector, and dried, followed by forming the negative electrode active material layer on the negative electrode collector to form a negative electrode.

Here, the thickness of the negative electrode collector was 16.3% of that of the negative electrode active material layer, and the negative electrode collector was formed of an electrodeposited copper foil having a tensile stress of 294.0 Mpa. A 16 μm-thick film separator of polyethylene (PE) was disposed between the electrodes, and the combination was wound and compressed to be inserted into a rectangular-shape can, and an electrolyte was injected into the rectangular-shape can to form a lithium secondary battery.

### Example 2

A lithium secondary battery was prepared as described in Example 1, except that rolled copper foil having a tensile stress of 970.0 Mpa was used as the negative electrode collector.

### Example 3

A lithium secondary battery was prepared as described in Example 1, except that rolled copper foil having a tensile stress of 970.0 Mpa was used as a negative electrode collector, and the thickness of the negative electrode collector was 17.6% of that of the negative electrode active material layer.

### Example 4

A lithium secondary battery was prepared as described in Example 1, except that rolled copper foil having a tensile stress of 970.0 Mpa was used as a negative electrode collector, and the thickness of the negative electrode collector was 24.2% of that of the negative electrode active material layer.

### Comparative Example 1

A lithium secondary battery was prepared as described in Example 1, except that an 8 μm-thick electrodeposited copper foil having a tensile stress of 220.3 Mpa was used as the negative electrode collector, and the thickness of the negative electrode collector was 8.7% of that of the negative electrode active material layer.

### Comparative Example 2

A lithium secondary battery was prepared as described in Example 1, except that rolled copper foil having a tensile stress of 970.0 Mpa was used as the negative electrode collector, and the thickness of the negative electrode collector was 25% of that of the negative electrode active material layer.

### Comparative Example 3

A lithium secondary battery was prepared as described in Example 1, except that the thickness of the negative electrode collector was 15% of that of the negative electrode active material.

Increases in thickness of the secondary battery according to Examples 1 to 4 and Comparative Examples 1 to 3 were analyzed. The increase in thickness (%) of the battery was estimated by measuring the thickness of a cell after the formation process on the basis of the thickness of the assembled battery, which was defined as 100%. When the increase in thickness is 120% or less, it is represented as “OK”, and when the increase in thickness is more than 120%, it is represented as “NG.”

Further, life span characteristics of the lithium batteries according to Examples 1 to 4 and Comparative Examples 1 and 3 were analyzed at room temperature. The life span characteristics at room temperature were measured by discharging the batteries at a charge/discharge rate of 1.0 C. and constant current (CC)/constant voltage (CV) of 4.35 V/2.5 V, and stopping the discharging for 10 minutes. The charge and discharge were sequentially performed for 100 cycles to measure the capacity maintenance (%) at the 100th cycle. When the capacity maintenance is 70% or more, it is represented as “OK”, and when the capacity maintenance is less than 70%, it is represented as “NG”.

The results are shown in Table 1 below.

TABLE 1

| | Thickness | Thickness | Tensile | | | | |
|---|---|---|---|---|---|---|---|
| | of | of | stress of | | | | |
| | negative | negative | negative | | | Capacity | |
| | electrode | electrode | electrode | Increase in | | maintenance at | |
| | collector | collector | collector | thickness | | 100^{th} cycle | |
| | (μm) | (%) | (MPa) | % | decision | % | decision |
| Example 1 | 15 | 16.3 | 294.0 | 120.0 | OK | 76.1 | OK |
| Example 2 | 15 | 16.3 | 970 | 117.2 | OK | 75.6 | OK |
| Example 3 | 15 | 17.6 | 970 | 114.8 | OK | 76.0 | OK |
| Example 4 | 15 | 24.2 | 970 | 110.8 | OK | 74.5 | OK |
| C. Example 1 | 8 | 8.7 | 220.3 | 134 | NG | 76.4 | OK |
| C. Example 2 | 15 | 25 | 970 | 110.5 | OK | 69.5 | NG |
| C. Example 3 | 15 | 15 | 294.0 | 123.5 | NG | 76.4 | OK |

Referring to Table 1, in Examples 1 to 4, as the thickness of the negative electrode collector is chosen in a range from 16.3 to 24.2% of the thickness of the positive electrode active material, the increase in thickness is estimated as 120% or less, which is represented as “OK.” However, in Comparative Example 3, as the thickness of the negative electrode collector corresponds to 15% of the thickness of the positive electrode active material, the capacity maintenance percentage at the 100th cycle is represented as “OK,” but the increase in thickness corresponds to 123.5%, which is represented as “NG.” Further, in Comparative Example 1 using the 8 μm-thick negative electrode collector, the rate of increase in thickness corresponds to 134%, which is also not good.

In Examples 1 to 4, as the thickness of the negative electrode collector is chosen in the range from 16.3 to 24.2% of the thickness of the positive electrode active material, the capacity maintenance percentage at the 100th cycle corresponds to 70% or more, which is represented as “OK”. However, in Comparative Example 2, as the thickness of the negative electrode collector is 25% of the thickness of the positive electrode active material, the increase in thickness is represented as “OK”, but the capacity maintenance percentage at the 100th cycle corresponds to 69.5%, which is represented as “NG.”

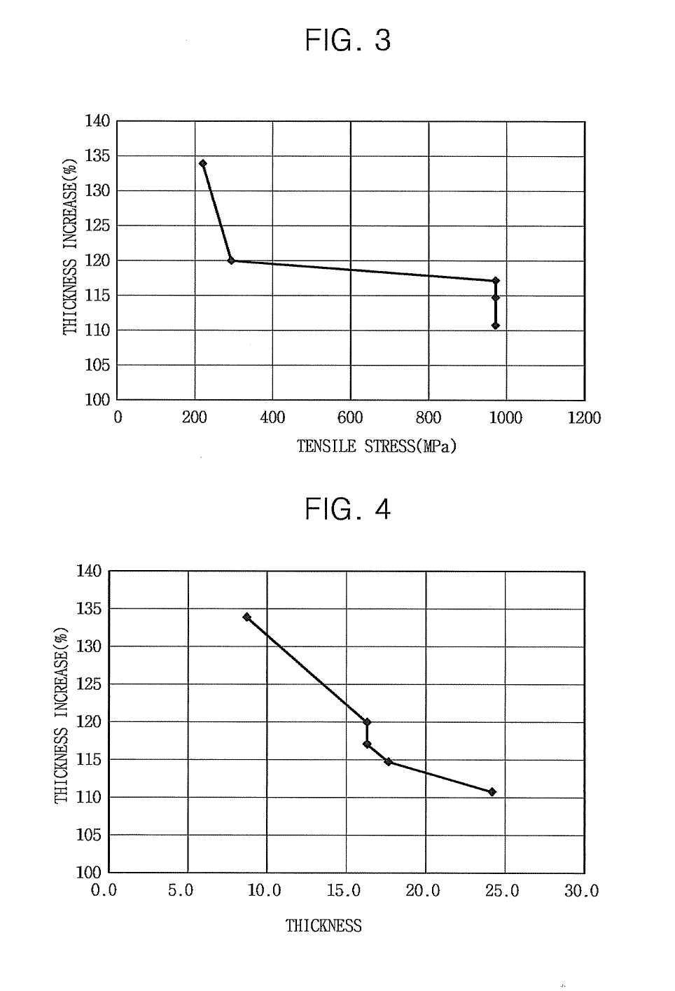

FIG. 3 is a graph showing the increase in thickness versus tensile stress of the negative electrode collector, and FIG. 4 is a graph showing the increase in thickness of the battery versus the thickness of the negative electrode collector. Referring to FIG. 3, when the tensile stress of the negative electrode collector satisfying a reference increase in thickness of 120% or less is than 294.0 MPa, the increase in thickness decreases.

Since the tensile stress is the factor generally dependant on the thickness of the negative electrode collector, as the thickness of the negative electrode collector increases, the tensile stress also increases. However, even with the same thickness, the tensile stress increases when the negative electrode collector is manufactured by rolling.

Accordingly, when the tensile stress of the negative electrode collector is 294.0 MPa or more, the increase in thickness of the battery can be decreased. Since the tensile stress increases as the thickness of the negative electrode collector is increased, the thickness of the battery can be reduced by increasing the thickness of the negative electrode collector. Thus, the tensile stress of the negative electrode collector may be 294.0 MPa or more.

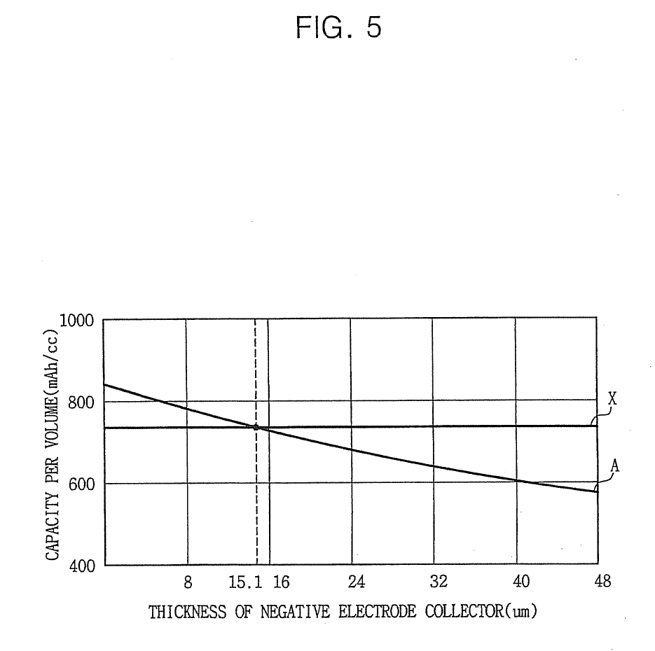

However, in order to prevent an increase in overall thickness of the battery, the stress limit that can be applied to the negative electrode collector may be increased by increasing the thickness of the negative electrode collector to prevent deformation of the jelly roll. That is, the increase in thickness of the battery may be reduced by increasing the thickness of the negative electrode collector. However, since the negative electrode collector does not affect the capacity, a base material that is too thick can reduce the capacity. Thus, as shown in FIG. 5, the thickness of the negative electrode collector should be selected based on the negative electrode active material.

That is, as shown in FIG. 4, the thickness rate of the negative electrode collector versus the negative electrode active material satisfying the reference increase in thickness of 120% or less is 16.3%. Thus, as the thickness of the negative electrode collector increases, the increase in battery thickness decreases.

However, as noted in Comparative Example 2, when the thickness of the negative electrode collector is 25% of the thickness of the positive electrode active material, the rate of increase in thickness corresponds to “OK”, but when the capacity maintenance at the 100th cycle is 69.5%, the increase in thickness corresponds to “NG”. Thus, in this aspect of the present invention, the thickness of the negative electrode collector may be 16.3 through 24.2% of the thickness of the negative electrode active material layer.

FIG. 5 is a graph showing capacity per volume versus thickness of the negative electrode collector. In FIG. 5, X is a base line representing capacity per volume when graphite is used as the negative electrode active material, and A represents capacity per volume according to the thickness of the negative electrode collector when a metal-graphite complex of these aspects of the present invention is used as a negative electrode active material. Here, in A, the capacity per volume as a function of the thickness of the negative electrode collector was calculated while fixing the thickness of the negative electrode including the negative electrode active material and the negative electrode collector and increasing the thickness of the negative electrode collector.

Referring to FIG. 5, when graphite is used as the negative electrode active material, the maximum capacity per volume is about 729.1 mAh/cc. Meanwhile, to develop a high-capacity lithium battery, the conventional graphite-based negative electrode active material is replaced by a negative electrode active material of the metal-graphite complex. The capacity per volume of the negative electrode was calculated while fixing the thickness of the negative electrode having a negative electrode active material and a negative electrode collector and increasing the thickness of the negative electrode collector. When the thickness of the negative electrode collector is 15.1 μm, the thickness of the negative electrode active material is too small, that is, as the portion capable of exhibiting a capacity gets smaller, the capacity is the same as about 729.1 mAh/cc, which is the maximum capacity per volume when graphite is used.

In other words, the metal-graphite complex was used as the negative electrode active material instead of the conventional graphite-based negative electrode active material to develop the high-capacity battery. However, as the thickness of the negative electrode collector is increased, that is, as the thickness of the negative electrode active material, or, the portion capable of exhibiting the capacity, is decreased, the negative electrode active material has the same capacity as the maximum capacity per volume of the graphite-based negative electrode active material. As a result, there is little or no advantage in using the metal-graphite complex as the negative electrode active material. Therefore, the thickness of the negative electrode collector according to this aspect of the present invention may be 15 μm or less.

However, in the case of A, Si was used as a metal material of the metal-graphite complex. Here, the content of Si was 9% of the total 100 wt % of the complex, which corresponds to a capacity per gram of the total active materials in the complex of 600 mAh/g,

That is, in order to achieve high capacity from the metal-graphite complex, the capacity per volume was calculated based on the content of the metallic material in the preferable range, and when the content of the metallic material versus the total the metal-graphite complex, that is, the Si content, is increased to increase the capacity per gram of the total active materials in the complex, even if the thickness of the negative electrode collector is more than 15 μm, it can achieve a higher capacity per volume than the base line exhibited when the graphite used as the negative electrode active material.

For example, when the thickness of the negative electrode having the negative electrode active material and the negative electrode collector is the same as that in the case of A, Si is used as a metallic material in the metal-graphite complex, and the capacity per gram of the total active materials in the complex corresponds to 760 mAh/g using 13% of the Si content of the total 100 wt % of the complex, even if the thickness of the negative electrode collector is 15.1 μm, the capacity per volume rises to about 928.3 mAh/cc. However, now when graphite is used, a higher capacity per volume than the typical maximum capacity per volume can be achieved, which can be useful in the case when the thickness of the negative electrode collector is more than 15 μm.

As a result, while the thickness of the negative electrode collector can be changed according to the content of the metallic material included in the metal-graphite complex, the preferable thickness is 15 μm or less, when the capacity per volume is calculated based on the capacity per gram of the total active materials in the complex of 600 mAh/g, which is obtained using the preferred content of the metallic material in order to achieve high capacity, that is, 9% Si content of the total 100 wt % of the complex. Thus, when the negative electrode collector is 15 μm, the tensile stress is 970.0 MPa. For this reason, the tensile stress of the negative electrode collector in this aspect of the present invention is preferably 970.0 MPa or less.

In addition, in Example 1, in which the increase in thickness of the battery is 120%, which is represented as “OK”, the tensile stress of the negative electrode collector is 294.0 MPa. Thus, in order to satisfy the desired increase in thickness of the battery in these aspects of the present invention, the tensile stress of the negative electrode collector should be at least 294.0 MPa. As a result, the preferable tensile stress of the negative electrode collector is in the range from 294.0 to 970.0 MPa.

Consequently, aspects of the present invention can provide a secondary battery reducing the thickness of the battery without degrading battery performance. Aspects of the present invention may also provide a secondary battery reducing the thickness of the battery without decreasing the capacity by controlling the thickness percentage of the negative electrode active material to the negative electrode collector and the tensile stress of the negative electrode collector.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A negative electrode comprising:
a negative electrode collector and a negative electrode active material layer deposited on the negative electrode collector,
wherein the negative electrode active material layer includes a negative electrode active material of a metal-graphite complex, and the thickness of the negative electrode collector is in the range from 16.3 to 24.2% of that of the negative electrode active material layer.

2. The negative electrode according to claim 1, wherein the tensile stress of the negative electrode collector is in the range from 294.0 through 970.0 MPa.

3. The negative electrode according to claim 1, wherein the thickness of the negative electrode collector is in the range from 9 through 15 μm.

4. The negative electrode according to claim 1, wherein the negative electrode collector is formed of at least one metal selected from the group consisting of stainless steel, nickel, copper, titanium and an alloy thereof.

5. The negative electrode according to claim 1, wherein the metal-graphite complex includes a graphite core particle, a metal particle disposed on the surface of the graphite core particle, and a carbon film coating the graphite core particle and the metal particle.

6. The negative electrode according to claim 5, wherein the metal particle includes at least one metal selected from the group consisting of Cr, Sn, Si, Al, Mn, Ni, Zn, Co, In, Cd, Bi, Pb and V.

7. An electrode assembly comprising:
a positive electrode including a positive electrode active material layer deposited on a positive electrode collector,
a negative electrode including a negative electrode active material layer deposited on a negative electrode collector, and
a separator separating the positive electrode from the negative electrode,
wherein the negative electrode active material layer includes a negative electrode active material of a metal-graphite complex, and the thickness of the negative electrode collector is in the range from 16.3 through 24.2% of that of the negative electrode active material layer.

8. The electrode assembly according to claim 7, wherein the tensile stress of the negative electrode collector is in the range from 294.0 through 970.0 MPa.

9. The electrode assembly according to claim 7, wherein the thickness of the negative electrode collector is in the range from 9 through 15 μm.

10. The electrode assembly according to claim 7, wherein the negative electrode collector is formed of at least one metal selected from the group consisting of stainless steel, nickel, copper, titanium and an alloy thereof.

11. The electrode assembly according to claim 7, wherein the metal-graphite complex includes a graphite core particle, a metal particle disposed on the surface of the graphite core particle, and a carbon film coating the graphite core particle and the metal particle.

12. The electrode assembly according to claim 11, wherein the metal particle includes at least one metal selected from the group consisting of Cr, Sn, Si, Al, Mn, Ni, Zn, Co, In, Cd, Bi, Pb and V.

13. A secondary battery, comprising:
an electrode assembly;
a can housing the electrode assembly;
a cap assembly disposed on top of the can; and
an electrolyte injected into the can, wherein
the electrode assembly includes a positive electrode having a positive electrode active material layer deposited on a positive electrode collector, a negative electrode having a negative electrode active material layer deposited on a negative electrode collector, and a separator separating the positive electrode from the negative electrode,
the negative electrode active material layer includes a negative electrode active material of a metal-graphite complex, and
the thickness of the negative electrode collector is in the range from 16.3 through 24.2% of that of the negative electrode active material layer.

14. The secondary battery according to claim 13, wherein the tensile stress of the negative electrode collector is in the range from 294.0 through 970.0 MPa.

15. The secondary battery according to claim 13, wherein the thickness of the negative electrode collector is in the range from 9 through 15 μm.

16. The secondary battery according to claim 13, wherein the negative electrode collector is formed of at least one metal selected from the group consisting of stainless steel, nickel, copper, titanium and an alloy thereof.

17. The secondary battery according to claim 13, wherein the metal-graphite complex includes a graphite core particle, a metal particle disposed on the surface of the graphite core particle, and a carbon film coating the graphite core particle and the metal particle.

18. The secondary battery according to claim 17, wherein the metal particle includes at least one metal selected from the group consisting of Cr, Sn, Si, Al, Mn, Ni, Zn, Co, In, Cd, Bi, Pb and V.

19. The secondary battery according to claim 13, wherein the electrolyte includes a non-aqueous organic solvent and a lithium salt.
